(19) United States
(12) Patent Application Publication
(10) Pub. No.: US 2014/0097753 A1
(43) Pub. Date: Apr. 10, 2014

(54) LED Lighting system for self-dissipation of heat

(71) Applicants: David Hui, Taipei (TW); Kuan-Hsiang Huang, Tainan (TW)

(72) Inventors: David Hui, Taipei (TW); Kuan-Hsiang Huang, Tainan (TW)

(21) Appl. No.: 13/573,744

(22) Filed: Oct. 5, 2012

(51) Int. Cl. H05B 37/02; H05B 37/00

(52) U.S. Cl. 315/112; 315/297; 315/193; 315/192

(57) ABSTRACT

A LED lighting system includes: a power unit for providing a power supply source for the lighting system, a LED circuit connected to the power unit for illuminating the light emitting diodes of the LED circuit, a heat control unit connected between the power unit and the LED circuit for controlling heat as produced, and a heat dissipating device thermally connected to the heat control unit for outwardly dissipating the heat produced by the lighting system for preventing light attenuation or damage of the light emitting diodes.

### BACKGROUND OF THE INVENTION

The Light emitting diode (LED) lighting systems are popularly used for modern lighting purposes. However, the heat produced by LED may cause light attenuation or damage after long time use. So, the heat produced by LEDs must be removed or dissipated in order to prolong their service life.

U.S. Patent Application Pub. No. US 2209/0184619 (the prior art) disclosed a LED illuminator by incorporating a temperature sensor, a controller and a fan in a light emitting diode illuminator, whereby a working temperature as sensed by the temperature sensor is compared with the predetermined working temperature in the controller, and the fan is adjusted by the controller to work at a suitable speed for cooling.

However, the prior art should be implemented with the fan for dissipating heat as produced by the light emitting diodes, to thereby increase production cost and maintenance problem of the LED illuminator.

The present inventor has found the drawbacks of the prior art and invented the present LED lighting system for self-dissipation of heat.

### SUMMARY OF THE INVENTION

The object of the present invention is to provide a LED lighting system including: a power unit for providing a power supply source for the lighting system, a LED circuit connected to the power unit for illuminating the light emitting diodes of the LED circuit, a heat control unit connected between the power unit and the LED circuit for controlling heat as produced, and a heat dissipating device thermally connected to the heat control unit for outwardly dissipating heat produced by the LED circuit for preventing light attenuation or damage of the light emitting diodes.

### BRIEF DESCRIPTION OF THE DRAWINGS

FIG. 1 is a block diagram of the present invention.

FIG. 2 is a circuit diagram of a first embodiment of the present invention.

FIG. 3 is a circuit diagram of a second embodiment of the present invention.

FIG. 4 is a side-view illustration showing a heat dissipating means provided in the present invention.

### DETAILED DESCRIPTION

As shown in the drawing figures, the present invention comprises: a power unit 1, a LED or light-emitting-diode circuit 2 connected to the power unit 1, a heat control unit 3 connected between the power unit 1 and the LED circuit 2 for controlling heat as produced, and a heat dissipating means 4 thermally connected to the heat control unit 3 for transferring heat from the heat control unit for dissipating heat outwardly.

The power unit 1 includes a power supply source which may be a direct-current or DC source (such as a battery), or an alternating-current (or AC) power supply source which may be rectified to be a DC power supply source.

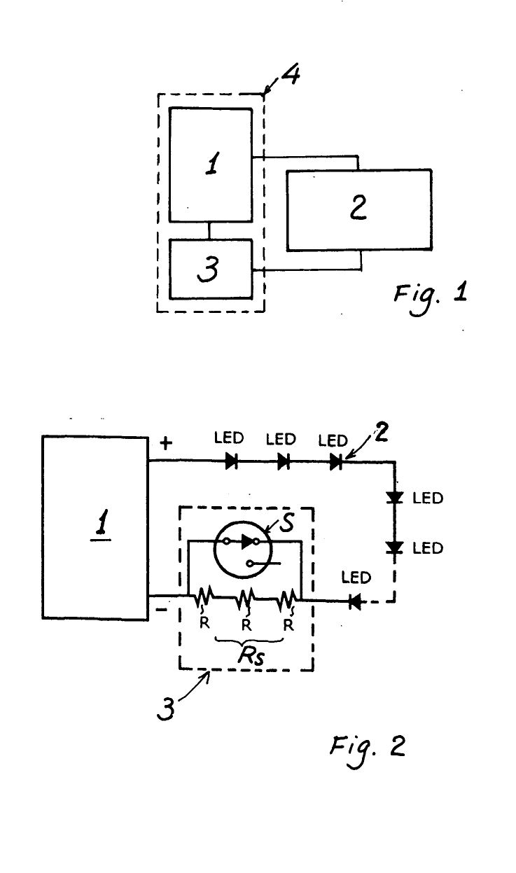

The LED circuit 2 may include a plurality of light emitting diodes connected in series between a positive pole (+) and a negative pole (−) of the power unit 1 through the heat control unit 3, thereby forming a constant-voltage LED circuit as shown in FIG. 2.

The LED circuit 2 may also include a plurality of LED strings 21 parallelly connected between a positive pole (+) and a negative pole (−) of the power unit 1 through the heat control unit 2, each LED string 21 consisting of a plurality of light emitting diodes connected in series between the positive pole and the negative pole of the power unit 1 through the heat control unit 3, thereby forming a constant-current LED circuit as shown in FIG. 3.

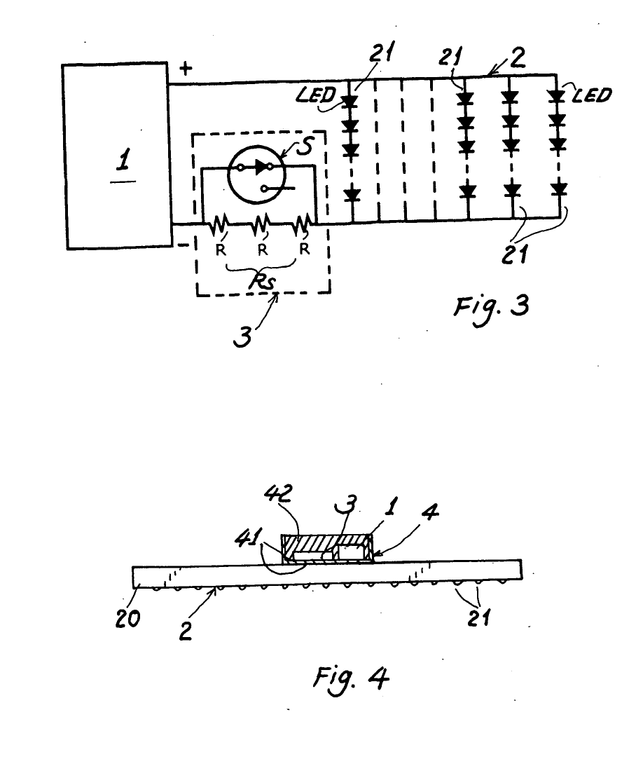

The light emitting diodes of the LED circuit 2 may be mounted in a lighting fixture or panel 20 as shown in FIG. 4.

The heat control unit 3 includes a temperature switch S and a resistor string Rs parallelly connected between the LED circuit 2 and the power unit 1, with the resistor string Rs including a plurality of resistors R connected in series, between the LED circuit 2 and the power unit 1 as shown in FIGS. 2 and 3.

The temperature switch S is connected between the LED circuit 2 and the power unit 1, which may be set at a pre-determined temperature (such as 60 degrees centigrade) to be automatically switched off when the temperature of the lighting system reaches the pre-determined temperature.

The resistor string Rs includes a plurality of resistors R connected in series between the LED circuit 2 and the power unit 1, with the resistor string Rs connected in parallel with the temperature switch S between the LED circuit 2 and the power unit 1.

The values of ohm or number of the resistors of the present invention are set or designed to balance the voltage reduction when the LEDs are turned on by the heat produced in the lighting circuit, thereby compensating the power value as pre-determined.

The heat dissipating means (or device) 4 includes a thermally conductive substrate or casing 41 connected to the heat control unit 3 for thermally conducting heat as produced from the resistors R of the heat control unit 3 and for dissipating such heat outwardly to the environment in order to “cool down” the LED circuit 2 for preventing overheating of the light emitting diodes of the LED circuit 2 for prolonging the service life of the LEDs and for preventing light attenuation of the LEDs.

A thermally conductive and electrically insulative adhesive 42 may be coated on or filled into the substrate or casing 41 of the heat dissipating means 4 for bonding the heat control unit 3 and said power unit 1 with the substrate or casing and for helping transfer of heat as produced from the heat control unit 3 for efficiently dissipating such heat. Such adhesive 42 may also provide a water proof effect for protecting the heat control unit 2 and the power unit 1 which may be embedded or encased in the same substrate or casing 41.

Naturally, such an adhesive 42 may be eliminated in practical commercial uses.

In operation, when the power unit 1 is actuated to power the LED circuit 2 for illuminating the LEDs, heat will be produced when converted into light. When the heat is built up to reach a pre-determined temperature (e.g. 60 degrees centigrade), the temperature switch S (normally closed) will be switched off so that the current flowing through the LED circuit 2 and the heat control unit 3 will flow into the resistors R connected in series, thereby producing heat due to thermal work W done by the resistors (W=i²r, wherein “i” is the current and “r” is the resistance) to be temporarily “stored” in the resistors R.

Since the resistors R are mounted on (or in) the substrate or casing 41 of the heat dissipating means 4, the heat as “stored” in the resistors R will be instantly dissipated outwardly through such a thermally conductive substrate or casing 41 of the heat dissipating means 4.

When the temperature of the circuit of the present invention is cooled down, the temperature switch S will be re-closed to operate the LED circuit 2 normally.

As shown in FIG. 4, the casing 41 of the heat dissipating means 4 may be separated from the lighting fixture or panel 20 of the LED circuit 2 to preclude (or insulate) the heat transferred from the resistors R towards the LEDs of the LED circuit 2.

Accordingly, the present invention is superior to the prior art or conventional LED lighting systems or illuminators with the following advantages:
1. The temperature switch S will be switched off, when the heat produced from the light emitting diodes is increased, to allow the current to pass through the resistors R to “store” heat in the resistors R connected in series, and instantly the heat will be outwardly dissipated by the dissipating means 4, thereby preventing the heat from transferring into the LED circuit 2 in order for protecting the light emitting diodes accordingly.
2. Since the circuit of the lighting system may itself dissipate the heat outwardly, a conventional fan for cooling the LEDs may no longer be required, thereby saving the cost.
3. The power unit 1 and the heat dissipating means 4 may be commonly encased in the casing 41 to be separated from the LED circuit 2 on the lighting fixture or panel 20, thereby greatly preventing heat transfer from the ristors R towards the LED circuit 2 and more efficiently protecting the light emitting diodes.

The present invention may dissipate the heat from the LED circuit automatically to protect the light emitting diodes. So, the present invention may be considered as an “Automatic Gain Control (AGC)” circuit for LED lighting system for automatically compensating (or conditioning) the power or heat in the LED circuit of LED lighting system for enhancing a better thermal management of LED lighting industry.

The ohms or number of the resistors are not limited in the present invention. The resistors are designed to balance the voltage reduction when the LEDs are turned on by the heat produced in the lighting circuit, thereby compensating the power value as pre-determined.

The present invention may be further modified without departing from the spirit and scope of the present invention. For example, a heat sink provided with fin structure or other heat dissipating mechanisms may be further added for a better heat dissipation of the LED lighting system.

I claim:

1. A LED lighting system comprising:
a power unit including a power supply source;
a LED circuit including a plurality of light emitting diodes connected between a positive pole and a negative pole of the power supply source;
a heat control unit including a temperature switch and a resistor string parallelly connected between the LED circuit and the power unit, with said resistor string including a plurality of resistors connected in series between the LED circuit and the power unit, whereby when a temperature reaches a pre-determined value of the temperature switch, the temperature switch is switched off and a current flows through the resistors to produce heat; and
a heat dissipating means thermally connected to the heat control unit for transferring the heat from the heat control unit and for dissipating the heat outwardly through said heat dissipating means.

2. A LED lighting system according to claim 1, wherein said power supply source includes a direct-current (DC) power supply source, and an alternating-current (AC) power supply source which is rectified to be a direct-current power supply source.

3. A LED lighting system according to claim 1, wherein said LED circuit includes a plurality of light emitting diodes connected in series between said positive pole and said negative pole of said power supply source, through said heat control unit, to form a constant-voltage LED circuit.

4. A LED lighting system according to claim 1, wherein said LED circuit includes a plurality of LED strings parallelly connected between the positive pole and the negative pole of said power unit through said heat control unit, each said LED string consisting of a plurality of light emitting diodes connected in series between said positive pole and said negative pole of said power unit through said heat control unit, forming a constant-current LED circuit.

5. A LED lighting system according to claim 1, wherein said temperature switch is connected between said LED circuit and said power unit, and is operatively switched off when a temperature of the lighting system reaches a pre-determined temperature as pre-set in said temperature switch.

6. A LED lighting system according to claim 1, wherein said heat dissipating means includes a thermally conductive substrate or casing connected to said heat control unit for thermally conducting heat as produced from the resistors of the heat control unit and for dissipating the heat outwardly.

7. A LED lighting system according to claim 6, wherein said substrate or said casing of said heat dissipating means is mounted thereon or therein with said heat control unit and said power unit.

8. A LED lighting system according to claim 6, wherein said heat dissipating means further includes a thermally conductive and electrically insulative adhesive coated on said substrate or filled into said casing of said heat dissipating means for bonding said heat control unit and said power unit on or in said heat dissipating means and for dissipating heat outwardly through said adhesive of said heat dissipating means.

9. A LED lighting system according to claim 1, wherein said plurality of light emitting diodes are mounted on a lighting fixture or panel, which is separated from a substrate or a casing of said heat dissipating means.
